(19) United States
(12) Patent Application Publication
(10) Pub. No.: US 2004/0091587 A1
(43) Pub. Date: May 13, 2004

(54) Use of extracts of Lamiaceae species for delaying color loss in irradiated meat

(76) Inventors: Vincent Sewalt, West Des Moines, IA (US); Jennifer Kerber, Des Moines, IA (US); Kristen Robbins, Ames, IA (US)

Correspondence Address: Kent A. Herink, The Financial Center, 666 Walnut Street, Suite 2500, Des Moines, IA, 50309-3993, US

(21) Appl. No.: 10/293,102

(22) Filed: Nov. 13, 2002

(51) Int. Cl. A23L 3/00

(52) U.S. Cl. 426/240

(57) ABSTRACT

An extract of plants of Lamiaceae species delays color loss in irradiated meat. The rosemary extract is applied prior to treatment with ionizing radiation followed by packaging in a modified atmosphere and storage under lighted retail display or under dark conditions. Onset of color loss of irradiated meat kept either in no light or in lighted conditions occurred much later than in irradiated meat not treated with the rosemary extract. In addition to the improvement in red color retention under lighted display, development of malonaldehyde but not alkenals was delayed with treatment using the rosemary extract.

### BACKGROUND OF THE INVENTION

The invention relates generally to the protection of meat against color loss during storage and, more particularly, to the use of extracts of plants of Lamiaceae sp., including rosemary (Rosemarinus officinalis), to protect meat treated with ionizing radiation from color loss, that is turning gray and/or brown, for an extended period of time.

Meat is an important yet highly perishable consumer product. The meat and grocery industries are continuously striving to improve the quality, safety, and shelf-life of meat products. Extending the shelf-life of meat would reduce the amount of meat which must be discarded due to spoilage by retailers of all sizes and would allow increased sales in retail outlets which do not have a high inventory turn-over, such as convenience stores. Processes which have been developed to extend shelf-life of meat include modified atmosphere packaging (MAP) and irradiation. While MAP techniques have enjoyed wide acceptance, initial low consumer acceptance of irradiated foods are only recently being overcome by improved irradiation techniques, improved packaging, and public education of the safety of irradiated foods. Consumer acceptance of irradiated foods can be further enhanced by the use of preservation products and techniques that are viewed as being natural and inherently safe.

The color of meat is one of the most important attributes influencing consumers' purchase decisions (Hood, D. E. 1980. Factors affecting the rate of metmyoglobin accumulation in prepackaged beef. Meat Sci. 4: 247-265). The pigment myoglobin is responsible for the color of meat. The relative proportions of three forms of myoglobin: purple reduced myoglobin, red oxymyoglobin, and brown metmyoglobin, impact the perceived acceptability of meats. The proportions of the myoglobin species shift in response to changes in the oxidation state of the heme iron, as well as the presence of ligands bound in the sixth coordination site of the iron atom in the heme ring. Reduced myoglobin contains reduced iron (Fe²⁺) with H₂O at the sixth coordination point. Reduced myoglobin has a strong affinity for binding O₂ at the sixth coordination site when conditions which increase oxygen solubility, such as low temperature and modified atmosphere, are present. Oxygenation of myoglobin forms oxymyoglobin, characterized by the preferred bright red color. The oxymyoglobin form is more resistant to oxidation of the heme iron to its ferric state when compared with reduced myoglobin (Millar, S. J., Moss, B. W., and Stevenson, M. H. 1996. Some observations on the absorption spectra of various myoglobin derivatives found in meat. Meat Sci. 42: 277-288). Metmyoglobin has iron in the oxidized state (Fe⁺³), and this causes a loss of the ability to reversibly bind oxygen, causing the meat to turn brown and appear unacceptable to consumers. Unfortunately, the lighting in common use in meat displays can accelerate the formation of the metmyoglobin species.

In order to extend the shelf life of meats several weeks to expand the market for meats, e.g., into convenience stores, two obstacles need to be overcome: a) assurance of food safety and enhanced freshness (i.e., absence of pathogenic bacteria and reduced levels of spoilage microorganisms); and b) extension of color shelf life. A very effective way to kill microorganisms and hence to ensure food safety is via irradiation. However, in order for stored irradiated meat to remain aesthetically attractive to customers, color stability needs to be enhanced. Irradiation poses various challenges to maintaining color in meat, namely, irradiation not only kills micro-organisms in meats, thereby enhancing food safety and reducing spoilage, but it is also breaks some molecular bonds in muscle and is capable of ionizing the iron in the porphyrin ring from ferrous to ferric iron, resulting in metmyoglobin formation and discoloration. Additionally, ionizing irradiation is also capable of generating free radicals, which, in turn, can promote oxidation reactions consuming oxygen, resulting in more rapid discoloration. Irradiation also denatures endogenous meat enzymes that prevent oxidation reactions consuming oxygen. Therefore, these enzymes that normally slow down the browning of meat become ineffective, resulting in accelerated meat browning.

Ionizing radiation is an effective and safe method to decrease pathogens and spoilage bacteria in meats. However, this process promotes the formation of free radicals and destroys naturally occurring enzymes, which may hasten the decline of product quality caused by lipid oxidation and color loss. Irradiation under modified atmosphere, i.e. under high nitrogen conditions, limits the formation of off-flavors from lipid oxidation reactions, but still suffers from accelerated color loss.

Rosemary extracts have known antioxidant properties which could aid in maintaining heme iron in oxymyoglobin in its ferrous state resulting in prolonged color stability. We postulated that the impact of rosemary extract would be most apparent under light exposure as light induces photo-oxidation. Our successful effort to overcome the challenge to color stability imposed by irradiation of meat described herein allows for longer retail shelf life, therefore extending the market for irradiated meat.

### SUMMARY OF THE INVENTION

The invention consists of the use of extracts of Lamiaceae species, and specifically rosemary (Rosemarinus officinalis), to preserve the color of meat that is to be treated with ionizing radiation. The extract may either be in the form of a liquid or a dry product. The extract is applied to meat which is subsequently irradiated to reduce any pathogenic and food spoilage bacteria. The treated meat is packaged using modified atmosphere packaging in which the package is flushed with a mixture of oxygen and nitrogen. The treated meat has extended color loss stability under both no light or dark conditions and when exposed to light, as for example in meat display cases.

In a preferred embodiment, the extract of rosemary is prepared using a blend of tetrafluoroethane and solvent having a boiling point higher than ambient temperature. While such extracts are typically in liquid form, they may be converted to a dry product, for example by spray drying or by dispersal on or absorbance by a carrier. Known antioxidant components of the rosemary extract include carnosic acid, camosol, rosmarininc acid and rosmanol. A preferred rosemary extract is Fortium™ sold by Kemin Industries, Inc., Des Moines, Iowa. The extract is applied to the meat at an inclusion rate of between about 50 and about 200,000 ppm and preferably between about 100 and 5000 ppm.

The meat is exposed to ionizing radiation to reduce the amount of any pathogenic and spoilage causing microorganisms that may be present to extend the shelf-life of the meat against spoilage. A preferred source of ionizing radiation is an electron beam at an energy level and dose rate sufficient to extend the safe shelf-life of the meat, and within the standards as may be prescribed and updated by the Food and Drug Administration and the Department of Agriculture. Present regulations are understood to limit the maximum energy level to 10 MeV and the dose to 7 kGy.

### BRIEF DESCRIPTION OF THE FIGURES

FIG. 1 is a graphical representation of the Hunter a values for irradiated ground beef samples, a control and samples treated with two different levels of a rosemary extract, and stored under simulated retail display lighting for up to twenty-one days.

FIG. 2 is a graphical representation of the Hunter a values for irradiated ground beef samples, a control and samples treated with two different levels of a rosemary extract, and stored in the dark for up to twenty-one days.

FIG. 3 is a graphical representation of the reflectance spectra of myoglobin, oxymyoglobin, and metmyoglobin expressed as percentage (%) reflectance.

FIG. 4 is a graphical representation of the reflectance spectra of two sets of samples of untreated irradiated ground beef and irradiated ground beef treated at two different levels with rosemary extract, one set of samples stored in the dark and the other set of samples stored under simulated retail display lighting after 7 days of storage.

FIG. 5 is a graphical representation of the reflectance spectra of two sets of samples of untreated irradiated ground beef and irradiated ground beef treated at two different levels with rosemary extract, one set of samples stored in the dark and the other set of samples stored under simulated retail display lighting after 17 days of storage.

FIG. 6 is a graphical representation of alkenal levels over twenty-one days in untreated irradiated ground beef and irradiated ground beef treated at two different levels with rosemary extract stored under simulated retail display lighting.

FIG. 7 is a graphical representation of alkenal levels over twenty-one days in untreated irradiated ground beef and irradiated ground beef treated at two different levels with rosemary extract stored in the dark.

FIG. 8 is a graphical representation of malonaldehyde levels over twenty-one days in untreated irradiated ground beef and irradiated ground beef treated at two different levels with rosemary extract stored under simulated retail display lighting.

FIG. 9 is a graphical representation of malonaldehyde levels over twenty-one days in untreated irradiated ground beef and irradiated ground beef treated at two different levels with rosemary extract stored in the dark.

### DETAILED DESCRIPTION OF PREFERRED EMBODIMENTS

The present invention provides compositions of rosemary extracts or its components having antioxidant activity, principally camosic acid, camosol, rosemarininc acid, and rosmanol, either singly or in combination, applied to meat which, following treatment with ionizing radiation, retains its fresh-appearing color over an extended period of time.

As used in this description, the following terms include at least the following meanings:

“Meat” includes uncooked meat of livestock, fish, and poultry, including whole carcasses, cuts of the same, and ground portions of the same, and may include additives incorporated into the meat as are known or may become known in the trade, all of which are suitable for treatment with ionizing radiation for the purposes of extending the time during which the meat may be stored and retain acceptable safety and quality standards.

“Ionizing radiation” includes gamma rays, electron beams, or X-rays which cause changes in exposed food at the molecular level, damaging or destroying living cells to either sterilize food for storage at room temperature, control pathogenic organisms, or delay spoilage of fresh food.

“Rosemary extract” includes products extracted from Rosemarinus officinalis plants which include one or more of the principal antioxidant chemicals camosol, carnosic acid, rosmanol, and rosemarininc acid, and specifically includes extracts of rosemary plant material made using tetrafluoroethane whether alone or in combination with another solvent or solvents. Rosemary extract may be in either liquid or dry product form.

“Delaying color loss” includes delaying the development of off-colors. By way of illustrative example, delaying color loss in beef is a delay in the development of gray and/or brown color of the beef at levels which are unacceptable to consumers.

Without being bound to any particular theory of action, it is believed that the antioxidant potential of rosemary extract aids in quenching free radicals generated during irradiation, replaces the function of endogenous antioxidant enzyme activity lost during irradiation, and aids in maintaining iron in oxymyoglobin in its ferrous state, producing as an overall effect a prolongation of color stability. The data presented herein indicate that enhanced protection from color loss is achieved both in the dark and under lighted storage conditions, and that the protective effect is more pronounced when meat is stored in the light. It is believed that the greater effect of rosemary extract on meat stored under light conditions is due to its ability to combat light induced photo-oxidation. The examples described herein also establish that the rosemary extract has only a minor impact on the already low level of off-flavor components of the irradiated meat, thus demonstrating that the antioxidant activities necessary to maintain color in irradiated meat are distinct from the antioxidant activities needed to control off-flavors.

### Example 1

Materials and Methods

Beef trimmings were purchased from a local distributor. The trimmings contained approximately 15-20% fat. The trimmings were randomly divided into three lots, each weighing 45 pounds. Each lot was coarsely ground using a ¼ inch die-plate affixed to a commercial meat grinder (Hobart, Troy, Ohio), after which each lot was treated with a selected amount of a rosemary extract (none, 1500 ppm, 3000 ppm of Fortium R10, w/w), dispersed thoroughly, and then subjected to a fine grind. Each lot of ground beef was subdivided into approximately 312 g. samples that were each placed on a polypropylene tray. A topical application of 500 ppm of the rosemary extract was then applied to the treated samples, resulting in a total treatment level of 2000 ppm and 3500 ppm. The trays were then placed individually into polyethylene bags, which were heat sealed after a 30-sec. nitrogen flush cycle (Komet Plus Vac20, Convenience Food Systems, Frisco, Tex.).

Irradiation was conducted at the Linear Accelerator Facility (LAF) at the Iowa State University Meat Laboratory. Samples were transported from the processing facility to the LAF in Styrofoam containers to maintain product temperature. Samples were exposed to the ambient temperature of the irradiator during treatment, and then they were returned to the containers after irradiation. Samples were irradiated by a CIRCE IIIR electron beam irradiator (Thomson-CSF, St. Aubin, France) with an energy level of 10 MeV and a dose rate of approx. 90.0 kGy/min. Samples were arranged in a single layer within trays on stainless steel transfer carts. For each transfer cart, one alanine dosimeter was attached to both the top and bottom surfaces of a single package. Irradiation doses were applied to the samples by exposing them to the electron-beam using a single-sided pass. Using a constant dose rate, the target dose of 1.5 kGy was achieved. The true absorbed doses were verified by inserting the alanine dosimeters into a 104 Electron Paramagnetic Resonance instrument (Bruker Instruments Inc., Billerica, Mass.). Each transfer cart was processed separately through the LAF.

All samples were repacked using a Tiromat Nova MAP packer (Convenience Food Systems, Frisco, Tex.) flushed with 80% oxygen/20% nitrogen. Repacked samples were taken to the Iowa State Meat Laboratory. Half of the samples were arranged in a single layer on racks in a cold room (2° C.) and exposed to lighting 24 h/day for the duration of the experiment (simulated retail light display). The light source (Philips, fluorescent light, 40-Watt Cool White) was approximately 30 cm from the sample surface. The intensity of the incident light reaching the samples was 2,018 lux. The other half of the samples was stored in the same cold room in the dark (inside a cardboard box).

Color was assessed by visual inspection and by Hunter analysis. Initial color measurements were performed shortly after post-irradiation repackaging. Subsequent color measurements were conducted every 2-3 days for 21 days. All of the samples remained in their original packaging during color measurement, and condensation was removed prior to analysis. A Hunter LabScan II Colorimeter (Hunter Laboratory, Inc., Reston, Va.) was used for color measurements. The instrument was standardized prior to each use by covering the white standard tile with a sample of packaging material. Values of the white standard tile were X=78.67, Y=83.31, and Z=86.40. Illuminant D65, 10° standard observer, and 2.5 cm viewing area and port areas were used. Three random readings per sample were recorded and averaged, and two samples per each treatment were analyzed. Reflectance measurements were collected at 10 nm increments using illuminant D65. Malonaldehyde levels and alkenal levels were monitored by the Saffest™ System (Safety Associates, Tustin, Calif.) during the study.

Results were statistically treated by analysis of variance (ANOVA) using 3-way and 2-way factorial designs, and by regression analysis using STATGRAPHICS® Plus for Windows v. 5.1, Quality and Design Version (Manuguistics, Inc., Rockville, Md, 2002).

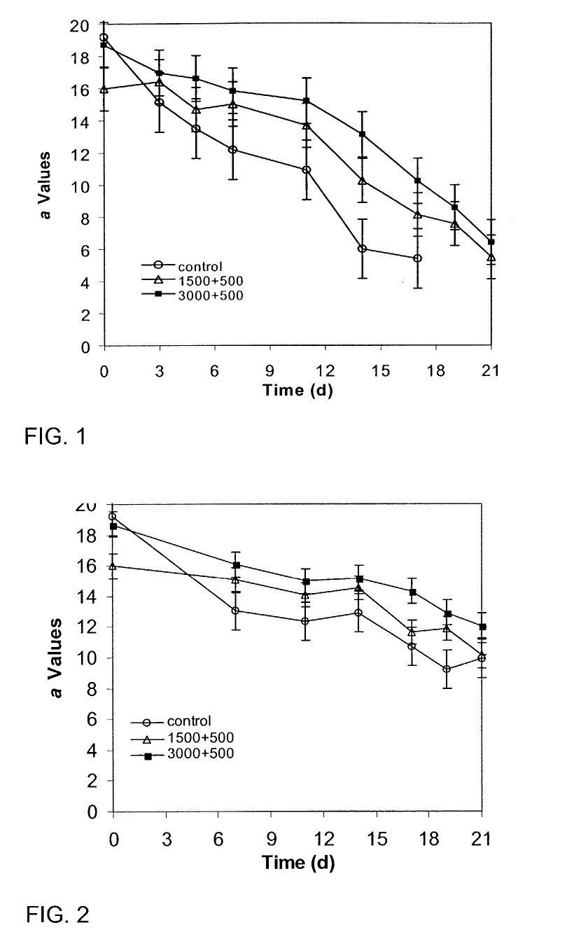

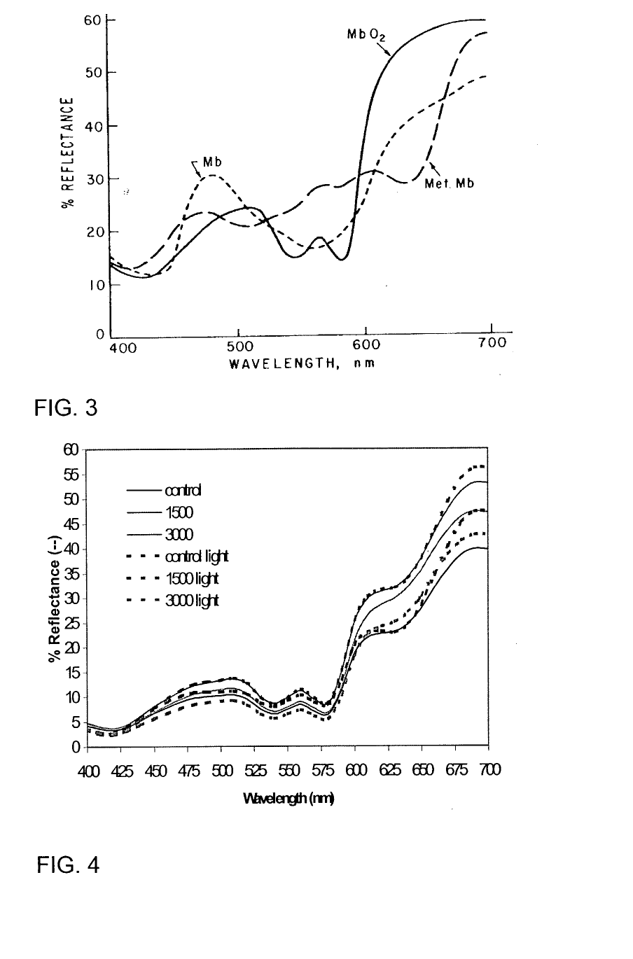

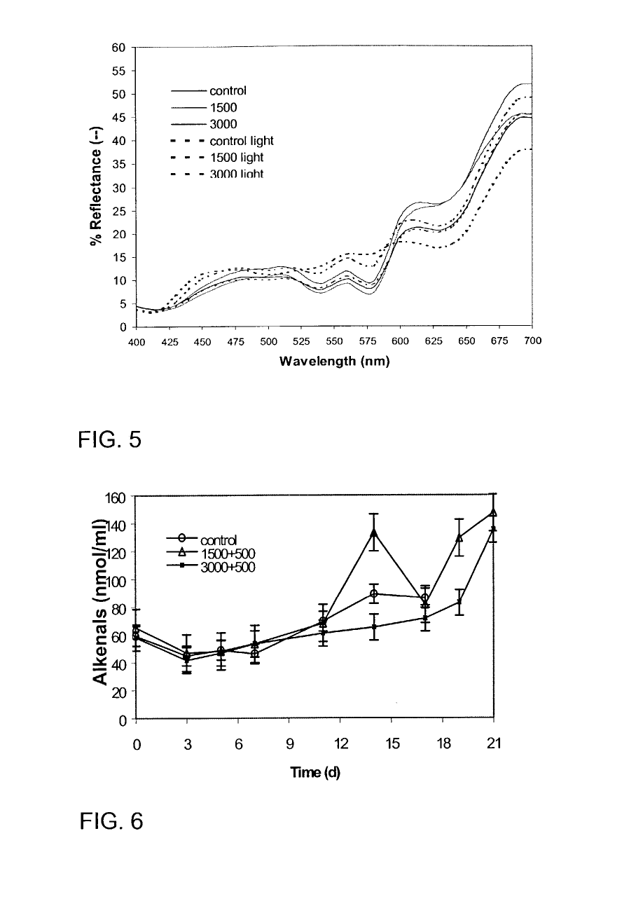

From the instrumental color measurements, the a (redness) values were compared for the packages of meat stored under the simulated retail lighted display (FIG. 1) and for packages stored in an opaque cardboard box, that is, in the dark (FIG. 2). Observations made during the visual inspection of packages were in close agreement with the measured a values. A previous study reported in the literature (Strange, E. D., Benedict, R. C., Gugger, R. E., Metzger, V. G., and Swift, C. E. 1974. Simplified methodology for measuring meat color. J. Food Sci. 39: 988-992) established baseline color spectra for the various forms of myoglobin (FIG. 3) and determined that the linear correlation coefficient (r) for “a” versus the hedonic score was 0.91±0.01. The reflectance spectra of irradiated meat sampled at day 7 (FIG. 4) and day 17 (FIG. 5) reveal that meat treated with rosemary extract retains the characteristic features of oxymyoglobin much better than control. The reflectance spectrum of oxymyoglobin has minimums around 540 nm and 580 nm, with high reflectance in the 600-700 nm region. On the other hand, the reflectance spectrum of metmyoglobin has increased reflectance in the yellow region, from 540-580 nm, and a relative minimum in the red region, specifically at 630 nm (Strange et al., ibid.). FIG. 4 clearly shows that the spectrum for the untreated sample had the characteristic metmyoglobin shoulder at 630 nm, whereas the spectra of the treated samples more closely resembled that of oxymyoglobin. When measured on day 17, the spectrum of the untreated sample stored under lights had increased reflectance from 540-580 nm, indicating significant metmyoglobin formation (FIG. 5). On the other hand, the spectrum for beef treated with 3000 ppm rosemary extract with storage under lights, still indicated a high percentage of oxymyoglobin represented by the minima at 540 nm and 580 nm.

Overall, statistically significant (P<0.001) effects of light exposure, sampling period, and rosemary extract treatment were established, but each of these three factors interacted significantly (P<0.05) with both of the other two factors (see Appendix I, tables 1-3). Although no differences in redness existed the day of processing (P>0.10; Appendix I, Table 4), significant color changes (P<0.01) in the untreated beef occurred by day 7 (Appendix I, tables 5-6). Samples treated with 1500 ppm rosemary extract maintained their full redness for about 11 days, and remained acceptable by visual standards until day 14.

The samples treated with 3000 ppm of rosemary extract, however, retained full redness through day 17, with metmyoglobin becoming the predominant pigment on day 19. Statistical analysis of the a values showed that there were significant (P<0.001) changes in the measured a values over the entire sampling period (Appendix I, tables 1-3), and that the treatments had a significant impact on color retention (Appendix I, tables 1-8). A previous study reported in the literature (Nanke, K. E., Sebranek, J. G., and Olson, D. G. 1999. Color characteristics of irradiated aerobically packaged pork, beef, and turkey. J. Food Sci. 64: 272-278) concluded that redness values for unirradiated beef were higher than irradiated samples throughout a 12-day lighted display time. These findings further emphasize the challenge of extending the shelf life of irradiated beef, and thus, the significance of the benefits of rosemary extract. Regression analysis (Appendix I, tables 9-11) of the a values over time revealed significantly (P<0.001) different slopes (Appendix I, table 12), confirming an impact of rosemary extract treatment on the rate of color loss from irradiated ground beef stored in the light.

When stored in the dark, the onset of color loss from irradiated ground beef occurred later when compared with storage under lights. These observations agree with conclusions from a published experiment citing that the metmyoglobin content of meat stored in the light was 5.5% higher than that of meat stored in the dark (Varnam, A. H. and Sutherland, J. P. 1995. Meat and Meat Products: Technology, Chemistry and Microbiology. Chapman & Hall, N.Y.). Visible color changes in the untreated beef occurred by day 17. By visual inspection, rosemary extract treatment further delayed the loss of color by 3-7 days. Statistical analysis of the a values showed that there were significant (P<0.001) changes in the measured a values over the entire sampling period, and that the treatments had a significant impact on color retention over the 17 days (Appendix I, table 2). Furthermore, regression analysis (Appendix I, tables 12-14) of the a values over time revealed significantly (P=0.028) different slopes (Appendix I, table 14), confirming an impact of rosemary extract treatment on the rate of color loss from irradiated ground beef stored in the dark

Lipid oxidation occurs due to the reaction of unsaturated lipids with oxygen, yielding hydroperoxides, which will subsequently degrade into secondary byproducts such as alkenals, alkanals, ketones, alkanes, etc. These volatile secondary compounds are the cause of off-flavors and off-odors, which are distinct from odors attributed with microbial spoilage. Although animal lipids are saturated and thus resistant to oxidation, sufficient quantities of polyunsaturated lipids are present in the phospholipid fraction of muscle cells to facilitate lipid oxidation (Varnam, et al., ibid.). In beef, 44% of the fatty acids within the phospholipid fraction contain two or more double bonds, compared to only 3.4% of the triacylglycerol fatty acids (Varnam et al., ibid.).

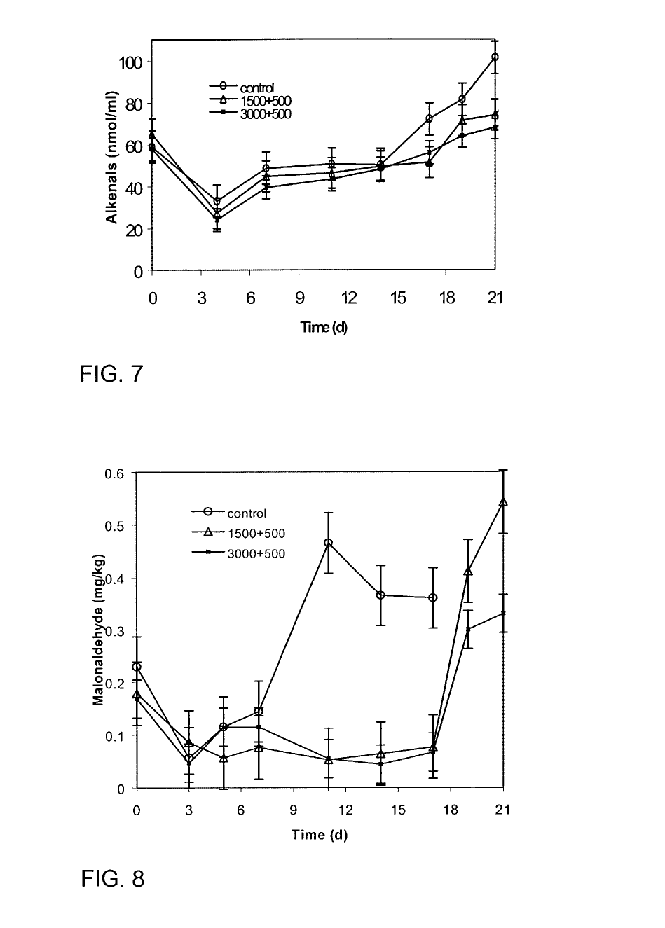

Pigment and lipid oxidation is closely coupled in beef, as an increase in one result in a similar increase in the other. Although the exact mechanisms are not completely understood, it is postulated that the free radicals formed during lipid oxidation may affect pigment oxidation by damaging metmyoglobin reducing systems inherent in beef (Varnam et al., ibid.). Additionally, irradiation destroys the endogenous enzymes and antioxidants, which prevent lipid oxidation in meat tissues. The levels of alkenals, secondary by-products of lipid oxidation, were monitored throughout the study in order measure the concentration of chemicals, which contribute to off-flavors and off-odors (FIGS. 6 and 7).

Significant (P<0.001) changes were seen in the alkenal levels over the sampling period caused by the effects of the treatments as well as the absence or presence of light (Appendix II, table 1). Samples stored under the light display exhibited elevated alkenal levels after 19 days, whereas those not exposed to light experienced minimal alkenal accumulation throughout the experiment. Treatment with Fortium R10 had a less significant (P=0.025) impact on alkenal levels in the meat stored in the dark than in the light (P<0.001), suggesting that light exposure has a slight pro-oxidant effect in irradiated ground beef. However, the alkenal levels for all of the samples did not reach levels that would result in product rejection, although the color of the ground beef appeared undesirable towards the end of the study. These results confirm that the antioxidant demands to maintain color in irradiated meat are distinct from the need to control off-flavors.

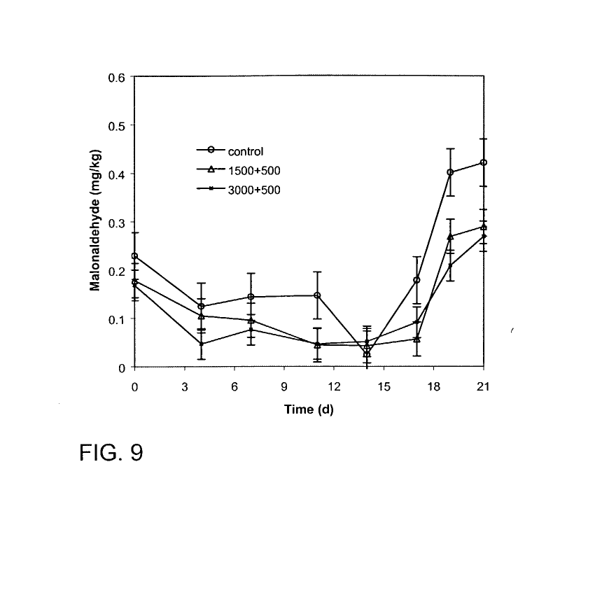

Malonaldehydes are also formed as secondary products of lipid oxidation, since they are breakdown products formed from hydroperoxides. Since these breakdown products are much smaller molecules than the original fatty acids, they are also more volatile and are responsible for the development of rancid off-flavors and off-odors. The measurement of malonaldehyde levels provides valuable insight concerning the early stages in the development of rancidity. Off-flavors caused by malonaldehyde levels above 0.4 mg/kg are distinguishable by sensitive individuals. Most people will only detect offensive off-flavors when malonaldehydes rise above 1.0 mg/kg. FIGS. 8 and 9 show the malonaldehyde levels measured during the experiment. Significant interactions (P<0.001) were observed between the treatment level, light exposure, and storage time for the resulting malonaldehyde levels (Appendix III, table 1). These relatively low levels appear to increase to distinguishable levels after about 19 days of storage in the dark irrespective of treatment. Over the first 17 days of testing, there was a measurable improvement (P=0.016) with rosemary extract treatment (as Fortium™ R10) attenuated malonaldehyde accumulation. For beef stored under light, treatment with rosemary extract effectively (P<0.01) aided in suppressing the malonaldehyde levels. For these samples, malonaldehydes markedly increased by day 11, but the impact of continuous light exposure is delayed with rosemary extract treatment, to 19 days.

Application of rosemary extract prior to modified atmosphere electron beam irradiation delayed the onset of color loss from irradiated ground beef stored under simulated lighted retail display conditions from 7 days (control) to 14 days (1500 ppm) and 17 days (3000 ppm). Onset of color loss of irradiated ground beef kept in the dark occurred much later than in the light, but was also further delayed by 3 to 7 days with rosemary extract applied at 1500 ppm and 3000 ppm, respectively. In addition to the improvement in red color retention under lighted display, development of malonaldehyde but not alkenals was delayed with rosemary extract treatment. The surprising finding of these results is that successful delay of color loss from irradiated ground beef can be achieved using rosemary extract applied prior to the irradiation step. This success in overcoming the limitation of poor color retention in irradiated meat enables meat irradiation technology to be commercialized in expanding markets such as convenience food stores.

The foregoing description comprise illustrative embodiments of the present inventions. The foregoing embodiments and the methods described herein may vary based on the ability, experience, and preference of those skilled in the art. Merely listing the steps of the method in a certain order does not necessarily constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

[image]

[image]

[image]

[image]

[image]

[image]

[image]

[image]

We claim:

1. A method of delaying color loss in meat during storage, comprising the steps of:
(a) treating meat with an extract of a plant of species of Lamiaceae; and
(b) exposing the treated meat to ionizing radiation at a level and over a period of time sufficient to extend the safe shelf-life of the meat.

2. A method as defined in claim 1, wherein the plant is from the species Rosemarinus officinalis.

3. A method as defined in claim 1, wherein the extract includes one or more chemicals from the group consisting of camosol, camosic acid, rosmanol, rosmarinic acid, and mixtures thereof.

4. A method as defined in claim 1, wherein the extract is an extract made using tetrafluoroethane.

5. A method as defined in claim 4, wherein the extract was made using one or more co-solvents.

6. A method as defined in claim 1, wherein the step of treating meat comprises applying or incorporating the extract.

7. A method as defined in claim 6, wherein the step of treating meat comprises adding, spraying, brushing, dipping, immersing, injecting, dispersal in a carrier, absorbance by a carrier, and combinations thereof.

8. A method as defined in claim 1, wherein the amount of extract used to treat the meat is between about 50 and about 200,000 ppm on a weight basis.

9. The method of claim 1, further comprising the step of packaging the treated, irradiated meat in a modified atmosphere.

10. The method of claim 1 wherein the ionizing radiation is from an electron beam.

11. The method of claim 1, wherein the delay in color loss is extended during storage of the treated irradiated meat under no light and lighted conditions, or a combination thereof.

12. The method of claim 1, wherein the delay in color loss is greater relative to untreated irradiated meat when stored under lighted conditions than when stored under no light.

13. Meat treated using the method of claim 1.

14. The meat of claim 1, wherein said meat is selected from the group consisting of beef, poultry, pork, lamb, fish, and seafood.

15. A method of delaying color loss in ground meat during storage, comprising the steps of:
(a) treating ground meat by applying between about 50 and about 200,000 ppm of a liquid extract of a plant of rosemary;
(b) exposing the treated meat to ionizing radiation at a level of up to about 10 MeV for a period of time to deliver a dose of up to about 7 kGy; and
(c) packaging the treated, irradiated meat in a modified atmosphere.
